(19) United States
(12) Patent Application Publication
(10) Pub. No.: US 2026/0290648 A1
(43) Pub. Date: Sep. 24, 2026

(54) WIRING MEMBER

(71) Applicant: SUMITOMO WIRING SYSTEMS, LTD., Yokkaichi-shi (JP)

(72) Inventors: Yukitoshi TERASAKA, Yokkaichi-shi (JP); Hidetsugu KUBOTA, Yokkaichi-shi (JP); Taiki SHIKATA, Yokkaichi-shi (JP); Hikaru NISHIO, Yokkaichi-shi (JP)

(73) Assignee: SUMITOMO WIRING SYSTEMS, LTD., Yokkaichi-shi (JP)

(21) Appl. No.: 19/572,732

(22) Filed: Mar. 19, 2026

(30) Foreign Application Priority Data
Mar. 20, 2025 (JP) 2025-046118

(51) Int. Cl. H01B 7/36; B60R 16/02; H01B 7/00; H01B 7/40; H01B 17/58

(52) U.S. Cl. CPC H01B 7/363; H01B 7/0045; H01B 7/40; H01B 17/583; B60R 16/0207

(57) ABSTRACT

Provided is a wiring member capable of managing the phase of each grommet relative to an electric wire. A wiring member includes: an electric wire; and a plurality of grommets each of which integrally covers a circumference of the electric wire. The plurality of grommets are arranged at intervals in an axial direction of the electric wire. Each of the plurality of grommets includes an orientation identification portion 12C for identifying an orientation of the grommet in a circumferential direction of the electric wire.

### CROSS-REFERENCE TO RELATED APPLICATIONS

This application claims priority of Japanese Patent Application No. JP 2025-046118 filed on Mar. 20, 2025, the contents of which are incorporated herein.

### TECHNICAL FIELD

The present disclosure relates to a wiring member.

### BACKGROUND

JP 2024-7713A discloses a technique in which fixing clips (fixing members) are attached to a wire harness (electric wire) at a plurality of different positions and the fixing clips are attached to a vehicle body to route the wire harness.

JP 2024-7713A is an example of related art.

### SUMMARY

In the case where fixing clips are attached to a wire harness at a plurality of different positions in the axial direction, if the fixing clips are attached to a vehicle body in a state in which the positions of the fixing clips in the circumferential direction of the wire harness are not aligned, the wire harness may be routed in a twisted manner relative to the vehicle body. For example, when the wire harness vibrates together with the vehicle body, the position of the wire harness may deviate from the originally intended position.

The present disclosure has been made based on the circumstances described above, and has an objective of providing a wiring member capable of managing the phase of each grommet relative to an electric wire.

A wiring member according to the present disclosure includes: an electric wire; and a plurality of grommets each of which integrally covers a circumference of the electric wire, wherein the plurality of grommets are arranged at intervals in an axial direction of the electric wire, and each of the plurality of grommets includes an orientation identification portion for identifying an orientation of the grommet in a circumferential direction of the electric wire.

According to the present disclosure, the phase of each grommet relative to an electric wire can be managed.

### BRIEF DESCRIPTION OF THE DRAWINGS

FIG. 1 is a perspective view showing a wiring member according to Embodiment 1;

FIG. 2 is an enlarged perspective view showing a grommet and its vicinity in the wiring member according to Embodiment 1;

FIG. 3 is an enlarged perspective view showing a fixing member according to Embodiment 1;

FIG. 4 is a cross-sectional view showing the wiring member according to Embodiment 1, cut in a direction orthogonal to the axial direction of an electric wire;

FIG. 5 is a perspective view showing a wiring member according to Embodiment 2;

FIG. 6 is an enlarged perspective view showing a grommet and its vicinity in the wiring member according to Embodiment 2; and

FIG. 7 is a perspective view showing the wiring member according to Embodiment 2 in a state in which the angular positions of wiring members in the circumferential direction of an electric wire are different.

### DETAILED DESCRIPTION OF PREFERRED EMBODIMENTS

First, embodiments of the present disclosure will be listed and described.
(1) A wiring member according to the present disclosure comprises: an electric wire; and a plurality of grommets each of which integrally covers a circumference of the electric wire, wherein the plurality of grommets are arranged at intervals in an axial direction of the electric wire, and each of the plurality of grommets includes an orientation identification portion for identifying an orientation of the grommet in a circumferential direction of the electric wire.

With the above configuration (1), the orientation of each grommet in the circumferential direction of the electric wire can be easily recognized using the orientation identification portion, so that the orientation of each grommet in the circumferential direction of the electric wire can be aligned easily. In addition, when attaching fixing members to the electric wire, the orientation identification portion can be used as a reference mark to align the orientation of each fixing member in the circumferential direction of the electric wire. Here, the orientation of the grommet in the circumferential direction of the electric wire means the angular position at which the orientation identification portion of the grommet is arranged when the electric wire is viewed in the axial direction.
(2) Preferably, the wiring member according to the above (1) includes a fixing member configured to be attached to each of the plurality of grommets, wherein the orientation identification portion is formed in a planar shape intersecting the circumferential direction on an outer circumferential surface of the grommet, and the fixing member includes a base end portion capable of being in surface contact with the orientation identification portion. With the above configuration (2), since the base end portion contacts the orientation identification portion in the plane direction, it is easy to position the fixing member in the circumferential direction of the electric wire while suppressing rotation.
(3) Preferably, in the wiring member according to the above (2), the fixing member includes a band extending from the base end portion and configured to cover the outer circumferential surface of the grommet in the circumferential direction, and a protrusion configured to contact the band is provided on the outer circumferential surface of the grommet. With the above configuration (3), the protrusion contacts the band, thereby increasing the number of contact portions between the fixing member and the grommet and increasing frictional resistance between the fixing member and the grommet, so that the band can be kept from being displaced in the circumferential direction relative to the grommet.
(4) Preferably, in the wiring member according to the above (1), an outer shape of each of the plurality of grommets is the same regular polygonal shape when viewed in the axial direction. With the above configuration (4), since each grommet has the same regular polygonal shape, the angular position of each grommet in the circumferential direction of the electric wire can be recognized more easily.
(5) Preferably, in the wiring member according to the above (4), each of the plurality of grommets is provided with an index portion for distinguishing at least one side of the regular polygonal shape from other sides of the regular polygonal shape. With the above configuration (5), since at least one side of each grommet can be distinguished from the other sides, it is possible to perform an operation of attaching the fixing member to the electric wire with reference to the side provided with the index portion.
(6) Preferably, the wiring member according to the above (1) comprises a fixing member integrally covering a circumference of each of the plurality of grommets. With the above configuration (6), the orientation of the fixing member can be kept from deviating relative to the electric wire.
(7) Preferably, in the wiring member according to any one of the above (1) to (6), an angular position of the orientation identification portion in each of the plurality of grommets in the circumferential direction relative to a center of the electric wire is aligned to the same position. With the above configuration (7), the electric wire can be routed inside a vehicle body without twisting.

Specific examples according to the present disclosure will be described below with reference to the drawings. The present disclosure is not limited to these examples, but is defined by the claims and intended to include all modifications within the meaning and scope equivalent to the claims.

### Embodiment 1

A wiring member 10 according to Embodiment 1 is routed inside a vehicle body (not shown). Note that the directional reference does not necessarily coincide with the directional reference when the wiring member 10 is routed inside a vehicle (not shown) or the like.

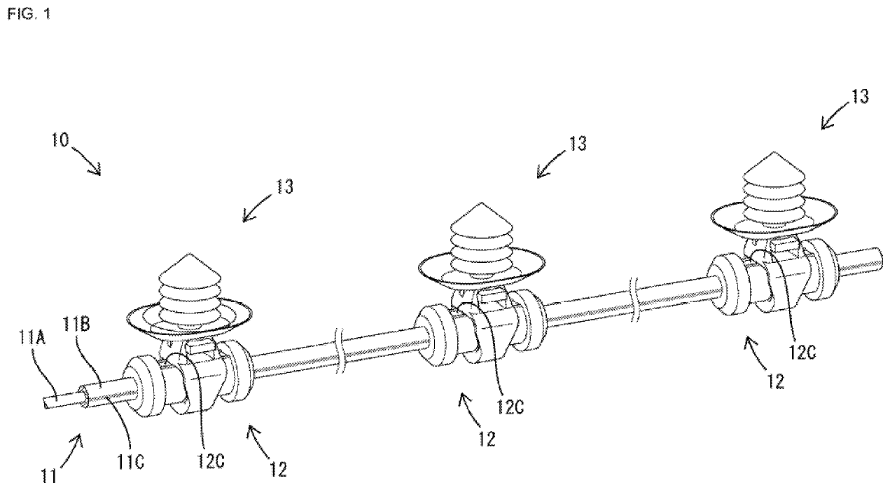

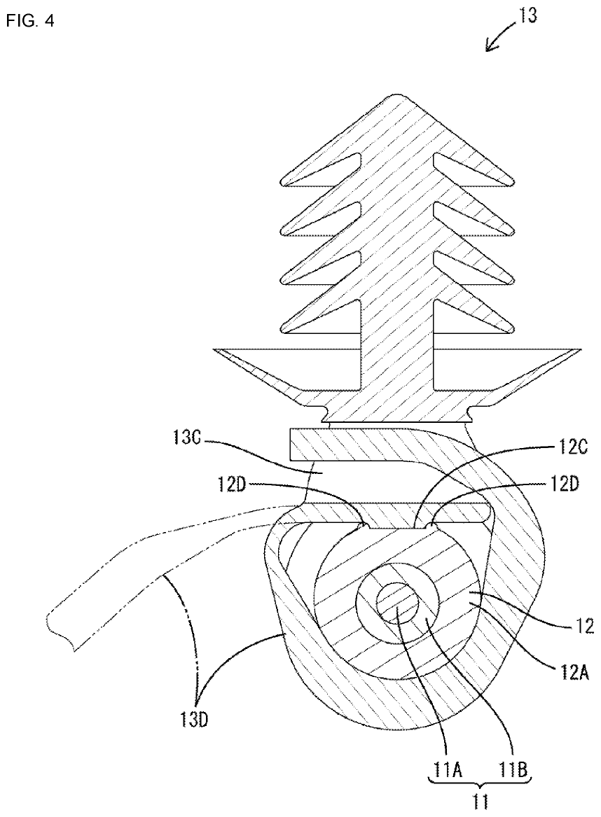

As shown in FIG. 1, the wiring member 10 includes an electric wire 11, a plurality of grommets 12, and a plurality of fixing members 13. The electric wire 11 is a well-known type of member in which a conductor 11A is surrounded by a coating 11B made of an insulating synthetic resin. The conductor 11A may be, for example, a single core wire composed of a single metal wire, or a stranded wire formed by bundling a plurality of metal wires. The cross-sectional shape of the outer circumferential surface of the coating 11B is a circle concentric with the conductor 11A (see FIG. 4). A marking line 11C extending in the axial direction is provided on the outer circumferential surface of the coating 11B.

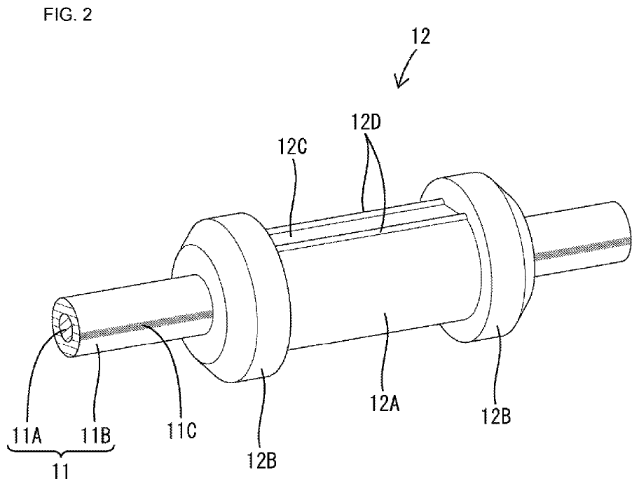

The plurality of grommets 12 are made of a synthetic resin such as an elastomer, silicone rubber, or the like. Each grommet 12 is formed so as to integrally cover the circumference of the electric wire 11. As shown in FIG. 2, each grommet 12 has a cylindrical shape extending in the axial direction of the electric wire 11. The grommets 12 are arranged at predetermined intervals in the axial direction of the electric wire 11 (see FIG. 1). Each grommet 12 includes a cylindrical main body portion 12A and enlarged-diameter portions 12B that are provided at both ends of the main body portion 12A and enlarged in the radial direction.

Each main body portion 12A includes an orientation identification portion 12C for identifying the orientation of the grommet 12 in the circumferential direction of the electric wire 11. For example, the orientation identification portion 12C is a part formed in a planar shape on the outer circumferential surface of the cylindrical main body portion 12A so as to intersect the circumferential direction of the electric wire 11 and be parallel to the axial direction of the electric wire 11. The orientation identification portion 12C is formed between the pair of enlarged-diameter portions 12B. On both circumferential sides of the outer circumferential surface of the main body portion 12A with the orientation identification portion 12C interposed therebetween, protrusions 12D that protrude in the radial direction and extend in the axial direction are provided. Thus, the orientation identification portion 12C is surrounded by the pair of enlarged-diameter portions 12B and the pair of protrusions 12D.

In the case of providing the grommets 12 on the electric wire 11 by integral molding, a mold for molding a grommet 12 is opened, and the electric wire 11 is placed in either the fixed-side mold half or the movable-side mold half of the mold. Here, the marking line 11C on the electric wire 11 is aligned with a marking engraved in the mold. The mold is then closed to mold the grommet 12. This operation is repeatedly performed at a plurality of different positions in the axial direction of the electric wire 11. As a result, a plurality of grommets 12 can be provided at different positions in the axial direction of the electric wire 11. When the grommets 12 are integrally molded and provided on the electric wire 11, the angular positions of the orientation identification portions 12C of the grommets 12 in the circumferential direction relative to the center of the electric wire 11 are aligned to a single position with reference to the marking line 11C of the electric wire 11 (see FIG. 1).

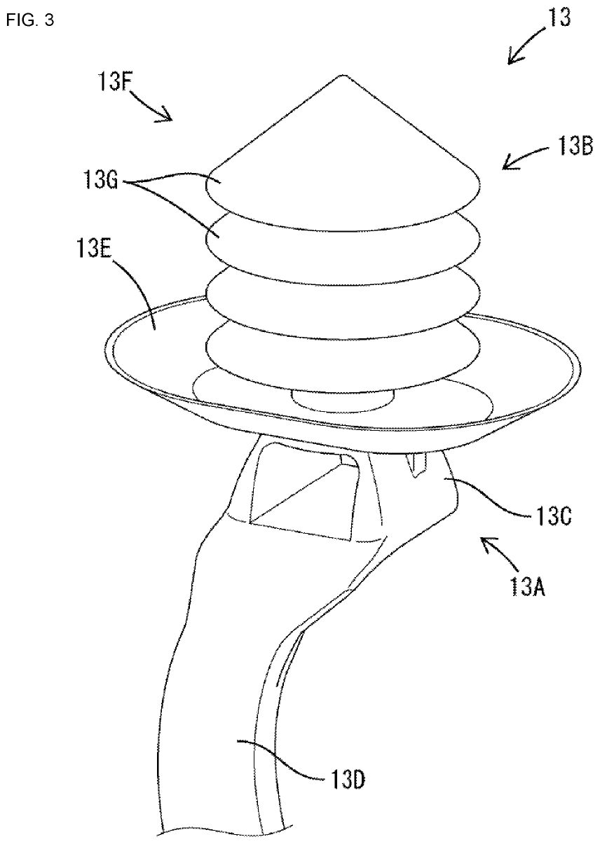

The plurality of fixing members 13 have the function of fixing the electric wire 11 to an attachment target in a vehicle body (not shown). As shown in FIG. 3, each fixing member 13 includes a base end portion 13A and a locking portion 13B. The base end portion 13A includes a polygonal tubular portion 13C and a band 13D extending in a strip shape from the polygonal tubular portion 13C. The base end portion 13A has a configuration similar to that of a known tie band. Locking protrusions are provided inside the polygonal tubular portion 13C (not shown). On the surface of the band 13D, a plurality of recesses are formed side by side in the extending direction (not shown). When the band 13D is inserted through the polygonal tubular portion 13C, the recesses of the band 13D engage with the locking protrusions of the polygonal tubular portion 13C. The band 13D is movable relative to the polygonal tubular portion 13C in the direction of insertion, but is restricted from moving in a direction opposite to the direction of insertion.

The locking portion 13B protrudes from one of the wall portions constituting the polygonal tubular portion 13C. The locking portion 13B includes a contact piece 13E that spreads in a dish-like shape adjacent to one of the wall portions constituting the polygonal tubular portion 13C, and a locking portion main body 13F that extends from the contact piece 13E to the side opposite to the polygonal tubular portion 13C. The locking portion main body 13F includes a plurality of locking pieces 13G that spread while being inclined toward the polygonal tubular portion 13C. The locking pieces 13G are arranged so as to overlap one another in the direction in which the locking portion main body 13F extends.

As shown in FIG. 4, in the case of attaching the fixing member 13 to the grommet 12, one of the wall portions constituting the polygonal tubular portion 13C is held in a state of being in surface contact with the orientation identification portion 12C, and the band 13D is wound so as to cover the outer circumferential surface of the main body portion 12A of the grommet 12 and is inserted through the polygonal tubular portion 13C. The polygonal tubular portion 13C is brought into surface contact with the orientation identification portion 12C that is located between the pair of enlarged-diameter portions 12B and between the pair of protrusions 12D. That is, the base end portion 13A is capable of being in surface contact with the orientation identification portion 12C.

The band 13D that has been inserted through and extended from the polygonal tubular portion 13C is then pulled and brought into contact with the outer circumferential surface of the grommet 12. At this time, the protrusions 12D come into contact with the wall portion of the polygonal tubular portion 13C to which the band 13D is connected. Thereafter, the band 13D that has been inserted through and extended from the polygonal tubular portion 13C is cut. In this way, the fixing member 13 is attached to the grommet 12. In each fixing member 13 attached to the corresponding grommet 12, one of the wall portions constituting the polygonal tubular portion 13C is in surface contact with the orientation identification portion 12C, so that the locking portions 13B of the respective fixing members 13 protrude in the same direction (see FIG. 1). In other words, the angular positions of the locking portions 13B in the circumferential direction of the electric wire 11 are aligned to a single position. The polygonal tubular portion 13C is restricted from being detached from the orientation identification portion 12C in the circumferential direction and the axial direction of the electric wire 11 by the pair of enlarged-diameter portions 12B and the pair of protrusions 12D.

As described above, the wiring member 10 according to Embodiment 1 comprises: the electric wire 11; and the plurality of grommets 12 each of which integrally covers the circumference of the electric wire 11. The plurality of grommets 12 are arranged at intervals in an axial direction of the electric wire 11. Each of the plurality of grommets 12 includes an orientation identification portion 12C for identifying the orientation of the grommet 12 in the circumferential direction of the electric wire 11.

With this configuration, the orientation of each grommet 12 in the circumferential direction of the electric wire 11 can be easily recognized using the orientation identification portion 12C, so that the orientation of each grommet 12 in the circumferential direction of the electric wire 11 can be aligned easily. In addition, when attaching the fixing members 13 to the electric wire 11, the orientation identification portion 12C can be used as a reference mark to align the orientation of each fixing member 13 relative to the electric wire 11.

The wiring member 10 includes the fixing member 13 attached to each of the plurality of grommets 12. The orientation identification portion 12C is formed in a planar shape intersecting the circumferential direction on the outer circumferential surface of the grommet 12. The fixing member 13 includes the base end portion 13A capable of being in surface contact with the orientation identification portion 12C. With this configuration, since the base end portion 13A contacts the orientation identification portion 12C in the plane direction, it is easy to position the fixing member 13 in the circumferential direction of the electric wire 11 while suppressing rotation.

The fixing member 13 includes the band 13D extending from the base end portion 13A and covering the outer circumferential surface of the grommet 12 in the circumferential direction. The protrusion 12D that contacts the band 13D is provided on the outer circumferential surface of the grommet 12. With this configuration, the protrusion 12D contacts the band 13D, thereby increasing the number of contact portions between the fixing member 13 and the grommet 12 and increasing frictional resistance between the fixing member 13 and the grommet 12, so that the band 13D can be kept from being displaced in the circumferential direction relative to the grommet 12.

An angular position of the orientation identification portion 12C in each of the plurality of grommets 12 in the circumferential direction relative to the center of the electric wire 11 is aligned to the same position. With this configuration, the fixing members 13 can be attached in a state in which their angular positions relative to the electric wire 11 are aligned, so that the electric wire 11 can be routed inside the vehicle body without twisting.

### Embodiment 2

A wiring member 20 according to Embodiment 2 differs from Embodiment 1 in the configuration of an orientation identification portion 112C. Other configurations are the same as those in Embodiment 1. Therefore, components that are the same as those in Embodiment 1 are given the same reference numerals and repeated description is omitted.

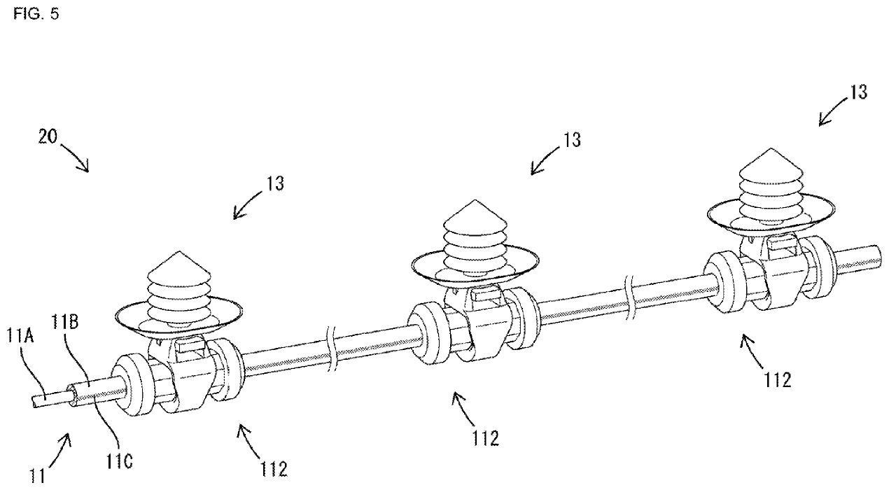

As shown in FIG. 5, the wiring member 20 includes an electric wire 11, a plurality of grommets 112, and a plurality of fixing members 13. The plurality of grommets 112 are made of a synthetic resin such as an elastomer, silicone rubber, or the like. Each grommet 112 is provided on the electric wire 11 by integral molding.

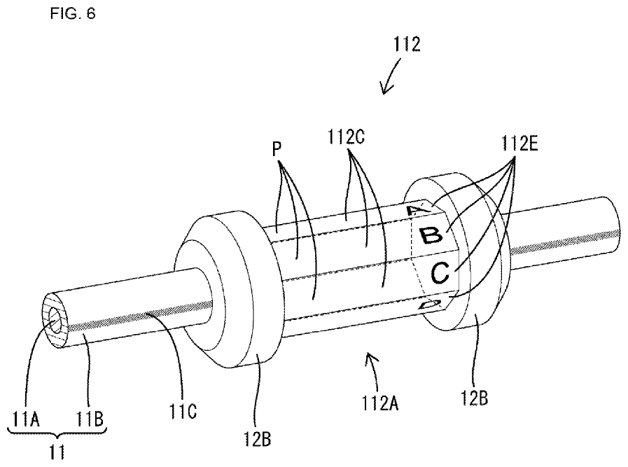

As shown in FIG. 6, each grommet 112 has a tubular shape extending in the axial direction of the electric wire 11. The grommets 112 are arranged at predetermined intervals in the axial direction of the electric wire 11 (see FIG. 5). Each grommet 112 includes a tubular main body portion 112A and enlarged-diameter portions 12B that are provided at both ends of the main body portion 112A and enlarged in the radial direction.

The main body portion 112A in each grommet 112 has the same regular polygonal shape, specifically, a regular octagonal shape, when viewed in the axial direction. In other words, the part of each grommet 112 that is interposed between the pair of enlarged-diameter portions 12B is made up of eight planes P. These planes P serve as orientation identification portions 112C for identifying orientations in the circumferential direction of the electric wire 11. The orientation identification portions 112C are formed between the pair of enlarged-diameter portions 12B.

Each orientation identification portion 112C is provided with an index portion 112E. Each index portion 112E has at least one letter, number, symbol, or the like formed in a convex or concave shape on the corresponding orientation identification portion 112C. For example, the index portions 112E are engraved in advance in a mold for molding a grommet 112, and are transferred to the respective orientation identification portions 112C by molding the grommet 112. The index portions 112E of the respective orientation identification portions 112C are different from each other. For example, in this embodiment, alphabetic letters A, B, C, D, E, F, G, and H are transferred as the index portions 112E onto the respective orientation identification portions 112C. E, F, G, and H are not shown in the drawings. Each orientation identification portion 112C can be distinguished from the other orientation identification portions 112C by the index portion 112E.

In the case of providing the grommets 112 on the electric wire 11 by integral molding, the electric wire 11 is placed in either the fixed-side mold half or the movable-side mold half of a mold for molding a grommet 112 in an opened state. Here, the marking line 11C on the electric wire 11 is aligned with a marking engraved in the mold. The mold is then closed to mold the grommet 112. When the grommets 112 are integrally molded and provided at different positions in the axial direction of the electric wire 11, the angular positions of the index portions 112E of the respective grommets 112 in the circumferential direction of the electric wire 11 are aligned to a single position with reference to the marking line 11C. For example, the angular positions of the index portions 112E corresponding to “A” are aligned to a single position with reference to the marking line 11C.

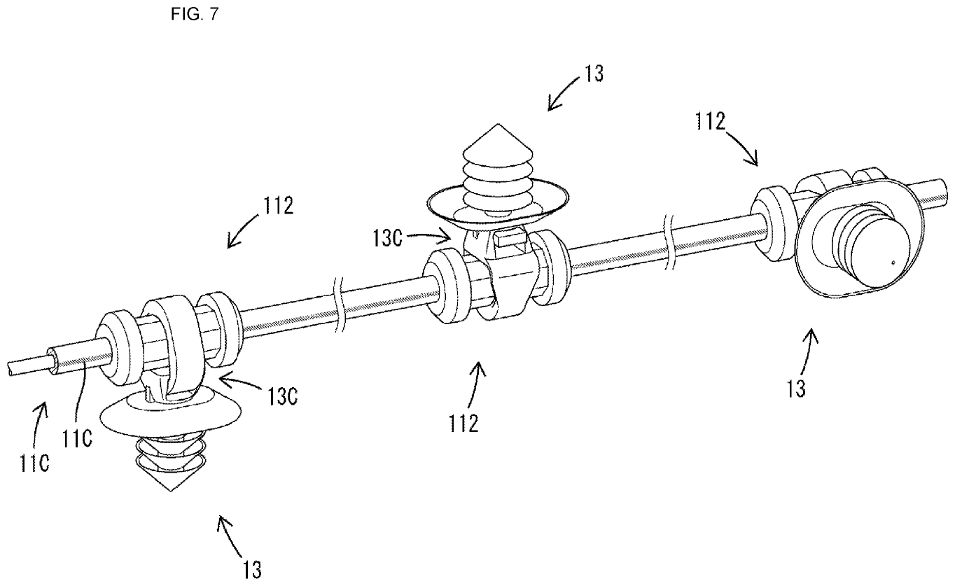

For example, as shown in FIG. 7, in the case of attaching a fixing member 13 to each grommet 112, the orientation identification portion 112C of the grommet 112 to be in surface contact with the polygonal tubular portion 13C of the fixing member 13 is designated using the index portion 112E. Thus, the angular position of the fixing member 13 in the circumferential direction of the electric wire 11 can be set in increments of 45 degrees.

An outer shape of each of the plurality of grommets 112 is the same regular octagonal shape when viewed in the axial direction of the electric wire 11. With this configuration, since each grommet 112 has the same regular octagonal shape, the angular position of each grommet in the circumferential direction of the electric wire 11 can be recognized more easily.

Each of the plurality of grommets 112 is provided with an index portion 112E for distinguishing one side of the regular octagonal shape from other sides of the regular octagonal shape. With this configuration, since each orientation identification portion 112C can be distinguished from the other orientation identification portions 112C in each grommet 112, it is possible to perform an operation of attaching the fixing member 13 to the electric wire 11 with reference to the side provided with the index portion 112E.

### Other Embodiments of the Present Disclosure

Embodiments 1 and 2 disclosed herein should be considered to be illustrative in all respects and not restrictive.

Unlike Embodiment 1 described above, no protrusions may be provided.

Unlike Embodiment 1 described above, a plurality of protrusions may be provided on the outer circumferential surface of the main body portion. In this case, when the band is arranged so as to cover the outer circumferential surface of the grommet, the protrusions come into contact with the inner circumferential surface of the band.

Unlike Embodiment 2 described above, the outer shape of the grommet is not limited to the same regular octagonal shape, and may be any regular polygonal shape.

Unlike Embodiment 2 described above, each index portion may be formed by printing at least one letter, number, or symbol on the corresponding orientation identification portion or by attaching tape with at least one letter, number, or symbol printed thereon to the corresponding orientation identification portion.

Unlike Embodiment 2 described above, only some of the plurality of orientation identification portions may be provided with an index portion. In detail, each grommet may be provided with an index portion for distinguishing at least one side of the regular polygonal shape from the other sides.

Unlike Embodiments 1 and 2 described above, the center of the orientation identification portion may be curved and recessed toward the electric wire, or a matte textured uneven surface may be provided.

Unlike Embodiments 1 and 2 described above, the wiring member may include a fixing member integrally covering the circumference of each of the plurality of grommets. Specifically, a shape for molding the locking portion is engraved into the mold for molding the grommet, and the grommet and the locking portion are integrally molded. With this configuration, the orientation of the fixing member can be kept from deviating relative to the electric wire. In this case, the locking portion functions as the orientation identification portion.

In this case, since the angular position of the locking portion (orientation identification portion) in the circumferential direction of the orientation identification portion relative to the center of the electric wire is aligned to the same position for each grommet, the electric wire can be routed inside the vehicle body without twisting.

Unlike Embodiments 1 and 2 described above, the orientation identification portion may be formed in a planar shape on the outer circumferential surface of the cylindrical main body portion so as to intersect the circumferential direction of the electric wire.

What is claimed is:

1. A wiring member comprising:
an electric wire; and
a plurality of grommets each of which integrally covers a circumference of the electric wire,
wherein the plurality of grommets are arranged at intervals in an axial direction of the electric wire, and
each of the plurality of grommets includes an orientation identification portion for identifying an orientation of the grommet in a circumferential direction of the electric wire.

2. The wiring member according to claim 1, comprising a fixing member configured to be attached to each of the plurality of grommets,
wherein the orientation identification portion is formed in a planar shape intersecting the circumferential direction on an outer circumferential surface of the grommet, and
the fixing member includes a base end portion capable of being in surface contact with the orientation identification portion.

3. The wiring member according to claim 2, wherein the fixing member includes a band extending from the base end portion and configured to cover the outer circumferential surface of the grommet in the circumferential direction, and
a protrusion configured to contact the band is provided on the outer circumferential surface of the grommet.

4. The wiring member according to claim 1, wherein an outer shape of each of the plurality of grommets is the same regular polygonal shape when viewed in the axial direction.

5. The wiring member according to claim 4, wherein each of the plurality of grommets is provided with an index portion for distinguishing at least one side of the regular polygonal shape from other sides of the regular polygonal shape.

6. The wiring member according to claim 1, comprising a fixing member integrally covering a circumference of each of the plurality of grommets.

7. The wiring member according to claim 1, wherein an angular position of the orientation identification portion in each of the plurality of grommets in the circumferential direction relative to a center of the electric wire is aligned to the same position.
